(19) United States
(12) Patent Application Publication
(10) Pub. No.: US 2022/0245344 A1
(43) Pub. Date: Aug. 4, 2022

(54) GENERATING AND PROVIDING INFORMATION OF A SERVICE

(71) Applicant: Deutsche Telekom AG, Bonn (DE)

(72) Inventors: Jascha Minow, Bensheim (DE); Carl Jahn, Wiesbaden (DE); Said El Mallouki, St. Goar (DE); Martin Michael Platschek, Berlin (DE)

(21) Appl. No.: 17/585,607

(22) Filed: Jan. 27, 2022

(30) Foreign Application Priority Data
Jan. 29, 2021 (EP) 21154284.0

(51) Int. Cl. G06F 40/284; G10L 13/08; G10L 15/26

(52) U.S. Cl. CPC G06F 40/284; G10L 2013/083; G10L 15/26; G10L 13/08

(57) ABSTRACT

A method for generating and providing information of a service includes: generating output text from the information; transferring the output text to a text analysis service which performs: an analysis of complexity of the output text; an analysis of punctuation marks and a determination of text passages of the output text relating to accentuation and pauses; an analysis of formatting of the output text; an analysis of word importance in the output text; and/or a classification of a recipient; outputting the result of the text analysis service in the form of output text analysis metadata; transferring the output text, the output text analysis metadata, and user metadata to a categorization service which selects at least one output medium for presenting the output text to a user; and presenting the output text to the user.

### CROSS-REFERENCE TO PRIOR APPLICATIONS

This application claims benefit to European Patent Application No. EP 21154284.0, filed on Jan. 29, 2021, which is hereby incorporated by reference herein.

### FIELD

The invention relates to a method for generating and providing information presented by a service to a user, wherein an output text is generated from the information, and wherein the output text is provided which is presented to the user. Furthermore, the invention relates to a system for implementing the method.

### BACKGROUND

Voice assistants, often also referred to as virtual assistants, are becoming increasingly widespread and are taking on an ever greater role in daily life. The days are long gone where the task was simply focused on recording a reminder or filling the shopping list for the next trip to the store with the aid of voice commands. Virtual assistants are especially developing into an important instrument of information output with which, for example, a company can enter into dialog with its customers.

The user addresses the respective virtual assistant via a telecommunications terminal which is connected to a network, in particular the Internet. A component of the virtual assistant is the service at the ready on the network, which generates the information to be presented to the user. The telecommunications terminal can, in particular, be a user's own smartphone, or a tablet or a computer, but may also a publicly accessible network access point with a connection to a virtual assistant.

It is thereby irrelevant whether the virtual assistant addressed by the user itself provides the service, or whether the service is made available by a third party. A service provided by a third party vendor enables this third party to be present on an unrelated virtual assistant under its own name, or at least with its own content. Given the “Alexa” voice assistant offered by Amazon, such services are referred to as “skills,” whereas the “Google Assistant” manages them under the term “action.” A dedicated service kept at the ready by the vendor of the virtual assistant is usually referred to as a “voice app.”

A service shall therefore be understood to mean the programming or functionality of the virtual assistant which generates the information that is to be presented to the user. This information is then provided as output text, converted into audio data and then presented to the user via speech output. The provision of the output text can take place as a reaction to a user input. Moreover, however, the output text can also be created as a reaction to information received from a third party, such as, for example, messages left on an answering machine, weather reports or warnings, or incoming messages from media.

Customers are also increasingly utilizing the virtual assistants for more complex questions that require a long response sentence or necessitate a differentiated response. For example, there may be different responses to the question “How is the weather in Darmstadt,” with very granular differences in the detailed information. The same also applies to news or messages which can be received by the virtual assistant for the user and be presented to the user.

However, for many customers, being able to completely follow the response and gleaning the necessary information poses a problem given longer output texts that are spoken aloud by the virtual assistant. An important reason that the response is not easily comprehensible to the customers is the lack of accentuation on punctuation marks, text formatting, or speed of the text output. Furthermore, the current virtual assistants do not consider the output medium. For some responses, however, it would be helpful to show further data, e. g., visual data, or to adapt the output medium using the given situation.

Current technical solutions that convert text that is intended for speech output to speech (TTS) take into account what are known as SSML tags. These special tags serve as markers in the response, in order to communicate to the TTS engine which particular passages of the response are to be made in another language. Furthermore, at present it is possible to specify, for the entire text, pauses between the words or the spoken words per minute.

### SUMMARY

In an exemplary embodiment, the present invention provides a method for generating and providing information of a service wherein an output text is generated from the information. The method includes transferring the output text to a text analysis service which performs: an analysis of complexity of the output text; an analysis of punctuation marks and a determination of text passages of the output text relating to accentuation and pauses; an analysis of formatting of the output text; an analysis of word importance in the output text; and/or a classification of a recipient; outputting the result of the text analysis service in the form of output text analysis metadata; transferring the output text, the output text analysis metadata, and user metadata to a categorization service which selects at least one output medium for presenting the output text to a user; and presenting the output text to the user.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 depicts a workflow in accordance with an exemplary embodiment of the invention.

### DETAILED DESCRIPTION

Exemplary embodiments of the invention further improve the intelligibility of information that is present in the form of output text for the addressed user.

In order to provide the output text in accordance with a method in an exemplary embodiment of the invention, in a first step the output text is transferred to an output text analysis service, which performs an analysis of the complexity of the response text; and/or an analysis of the punctuation marks and a determination of text passages of the output text which are important for accentuation and the pauses; and/or an analysis of the output text formatting; and/or an analysis of the word importance in the output text; and/or a classification of the recipient, wherein the result of the output text analysis service is output in the form of output text analysis metadata, and, in a second step, the response text, the output text analysis metadata, and user metadata are transferred to a categorization service which selects at least one output medium with which the output text is presented to the user.

Exemplary embodiments of the invention further provide a system having an input medium and an output medium connected to a network, wherein the network comprises the service, the output text analysis service, and the categorization service.

In an exemplary embodiment, the output text is analyzed with at least one of the cited techniques, the determination of the complexity, the punctuation marks, in particular the accentuation and pauses associated therewith, as well as the text formatting, for example the paragraphs, indentations, and enumerations of the output text. This output text analysis serves to extract properties and markers from the output text which are important for the intelligibility of the speech output. In an exemplary embodiment, the output medium for the speech output is categorized, that is to say it is determined on which output medium the speech output of the output text is to be played back. This can be, for example, the telecommunications terminal of the user, peripheral devices connected thereto, for example via Bluetooth, or a playback device connected to the network, such as a television, a radio, and a loudspeaker.

With the aid of these two steps, the intelligibility of the speech output of the output text is markedly improved.

In a first step, for this purpose the generated output text is subjected to an analysis. The output text analysis metadata resulting from the analysis are then made available, together with the output text, to the next step of the categorization of the output medium.

For generating the speech from a given output text, according to the invention it is possible to analyze the output text with at least one of the described analysis techniques, which are described in more detail in the above order.

The technique mentioned first is the complexity analysis. The determination of the complexity preferably takes place via a categorization of the text, in particular with the aid of a machine learning model, which categorizes the text and determines a complexity score. The index determined in this way assesses the readability of a response text. Such complexity or readability scores are known; they provide a speech and text genre-specific assessment and output a numerical value. For example, with respect to the text genre, they distinguish the readability of general information, a scientific content, a novel, or a personal message.

The analysis of the punctuation marks and determination of the text passage, which is important for accentuation and the pauses, preferably takes place via tokenization of the text, and/or a word and/or character search based on predefined formal grammar. The tokenizer splits the output text into logically cohesive units, what are known as tokens, whereas the formal grammar can be used to establish whether a recognized word or character is an element of a language.

The text formatting/structure analysis advantageously uses regular grammar or language. Text formatting, for example a paragraph, an indentation, or an enumeration, is hereby found and marked for further processing. With the aid of this analysis, it is possible in particular to establish linguistic pauses and accentuations that improve the intelligibility of the speech output.

The word importance analysis relates to the emphasis or accentuation of relationships in the output text. Special characteristics are hereby determined in the output text; moreover, user preferences can be incorporated as well. This can take place in particular using a machine learning model. Given this analysis it is beneficial to linguistically emphasize particular information and to address special features in dialects/languages. These relationships are explained in more detail below using four examples.

A telephone number from an answering machine message should be spoken more slowly and very clearly in order to give the customers the opportunity to write this number down.

For travel directions, it is important to stress particular instructions more clearly than others, for example “After the RED building, make a right.” The accentuation is capitalized here and in the following example

More important information in a text should be linguistically emphasized, for example “Donald Trump was NOT re-elected as U.S. President.”

In response to the question of a user “What is XY in English,” the output text “The English term for XY is ABC” is generated. The pronunciation of the translated word should thereby take place according to English phonetics.

Another technique relates to the determination of the recipient of the message. Which group or which person is considered to be the recipient of the message, for example a family, a child, or an adult, and in which polite form the recipient the recipients is or are addressed, for example formally or informally, are hereby preferably classified by a machine learning model.

The categorization of the output medium takes place via, in particular, automatic grading of the output text using various criteria. On this basis, an output takes place via the output media appropriate for the respective content. Responses are thus categorized by the system and routed to the appropriate output medium, for example in order to protect private data, increase intelligibility, and enable new applications for the virtual assistant.

The categorization of the text output preferably takes place based on the actual content of the text output. In addition to the content of the text output, criteria for this may also be the question that is posed or the output media known for this user. The source of the text output, thus the service or skill that is used, may also be incorporated into the categorization, as well as possibly existing user specifications for the respective service/skill. The categorization preferably takes place via calculation of a confidentiality score which is associated with the text output of the service.

For example, a message from the answering machine may be classified as private, but as particularly urgent based upon its content. Due to this categorization, the virtual assistant can now ask the user on which channel or output medium they would like to receive the response. Preferably, the user can also specify this in advance by way of a setting.

The channel or the output medium can be, for example, a companion app, a direct audio playback on the input medium, or the output via Bluetooth to a headset. The VoiceID technology is preferably used for the correct identification of the user. If there is already a setting in the profile of the user, for example “forward to the companion app,” for the particular category and classification, this is executed accordingly.

If a response is classified as being a public response, such as a news update or a severe weather warning, it is preferably played back immediately, as was done previously. Of course, the user thereby has the option of configuring the respective categories according to their usage profile. Depending on with which devices the user interacts with the virtual assistant, the transmission may take place via a companion app, a Bluetooth headset connected to the device, a headset connected to the smartphone, a response card in the companion app, or another route. Resulting from this is the advantage that the response can be sent to the correct output medium in a user-specific manner.

Furthermore, the output text analysis metadata can be used to select the correct output medium. If a knowledge question is to be answered, under the circumstances it may be advantageous to display further non-linguistic data, for example visual data such as images or even videos. This enables visual support of the spoken word and also faster comprehension capability via images, e.g., in the case of a weather forecast. However, if the input medium does not support this type of data, another existing output medium should advantageously be selected for the additional representation. It is thus possible to send a response in text form, including images, to an output medium with a screen (visual support of the spoken word), and to forward the audio output to another device.

After the analysis and categorization of the response text according to the invention, the speech output information presentation is generated accordingly and, in particular, is sent as speech output to the respective output medium or provided to it.

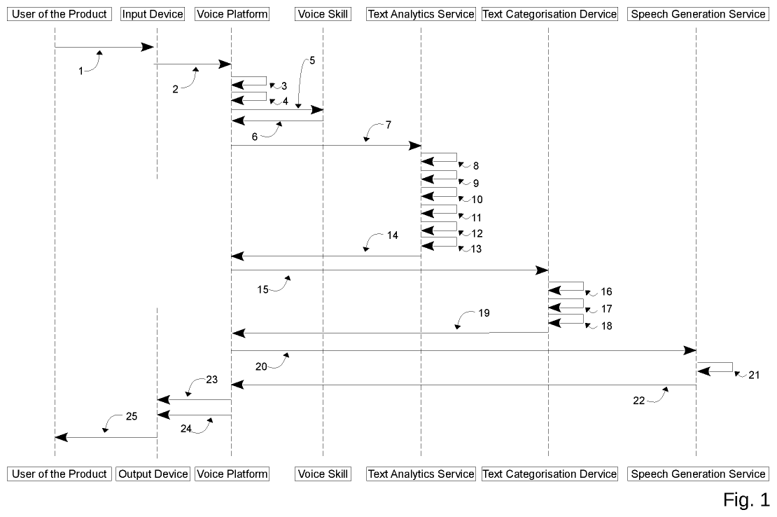

In the following, a workflow of a method according to an exemplary embodiment of the invention is explained in more detail using the flowchart shown in FIG. 1. The dotted lines thereby show the individual objects of the method, the user “User of the Product”, the telecommunications terminal “Input device”, and the further services which perform method steps. The arrows between the objects show a data transfer to another object; arrows pointing back to the same object show a method action within the object. The method workflow proceeds from top to bottom.

The method begins with a question 1, entered by speech, of the “User of the Product”, transmitted by the “Input Device” as audio data 2 via the network to the “Voice Platform” of the virtual assistant. From the “Voice Platform”, the audio data are converted via a speech to text (STT) function 3 and interpreted per natural language understanding (NLU) 4.

The data obtained in this way are transferred to the service, referred to here as a “voice skill,” see arrow 5. The output text generated by the “voice skill” is received by the “Voice Platform” (arrow 6) and transmitted to the “Text Analytics Service” (arrow 7). The “Text Analytics Service” performs the following analysis techniques: the analysis of the complexity of the output text 8, the analysis of the punctuation marks and determination of text passages of the output text 9 which are important for accentuation and the pauses; the analysis of output text formatting 10; the analysis of the word importance in the output text 11; and the classification of the recipient 12.

Subsequently, from this the text analysis generates metadata 13 and sends these back to the “Voice Platform” (arrow 14).

The text analysis metadata are transferred to the “Text Categorization Service” (arrow 15) together with metadata regarding the output text, available user metadata, which can include information about the “User of the Product” and output media available to them, user specifications regarding the service, and the content of the information. The categorization according to content 16, the determination of the confidentiality score 17, and the selection 18 the output medium are performed by this service.

The metadata thus determined are transmitted again to the “Voice Platform” (arrow 19), and from there, together with the output text and all previously generated metadata, to the “Speech Generation Service” (arrow 20). There, the audio data of the speech output are generated 21 and transmitted again to the “Voice Platform” (arrow 22). This transmits the audio data to the output medium “Output Device” or provides it for the “Output Device”. The “Output Device” can be identical to the “Input Device”, as is shown by arrow 23, or can also be an additional output medium, for example to present visual data, as is shown by arrow 24. The output medium or media then present to the “User of the Product” the output text of the service which has been analyzed and converted according to the invention (arrow 25).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for generating and providing information of a service wherein an output text is generated from the information, the method comprising:
transferring the output text to a text analysis service which performs:
an analysis of complexity of the output text;
an analysis of punctuation marks and a determination of text passages of the output text relating to accentuation and pauses;
an analysis of formatting of the output text;
an analysis of word importance in the output text; and/or
a classification of a recipient;
outputting the result of the text analysis service in the form of output text analysis metadata;
transferring the output text, the output text analysis metadata, and user metadata to a categorization service which selects at least one output medium for presenting the output text to a user; and
presenting the output text to the user.

2. The method according to claim 1, wherein the analysis of the complexity of the output text takes place via a readability index.

3. The method according to claim 1, wherein the analysis of the punctuation marks is performed via tokenization, and/or the determination of text passages of the output text is performed via predetermined formal grammar and/or a regular language.

4. The method according to claim 1, wherein the analysis of the output text formatting takes place via regular grammar.

5. The method according to claim 1, wherein the user metadata include information about the service.

6. The method according to claim 1, wherein the user is identified, and the user metadata contain user specifications regarding the service or content of the information.

7. The method according to claim 1, wherein the user is identified via VoiceID.

8. The method according to claim 1, wherein the user is asked about a desired output medium.

9. The method according to claim 1, wherein the output medium is selected according to a confidentiality of the information.

10. The method according to claim 1, wherein a further output medium is selected via which visual data associated with the output text are presented to the user.

11. The method according to claim 1, wherein at least a portion of the output text is presented to the user as speech output.

12. The method according to claim 1, wherein an input of a user is a speech input which is transmitted from an input medium to a speech recognition unit.

13. A system, comprising:
a network comprising a service, a text analysis service, and a categorization service; and
an input medium and an output medium connected to a network, wherein the network is configured to:
transfer, to the text analysis service, an output text generated from information;
wherein the text analysis service is configured to perform:
an analysis of complexity of the output text;
an analysis of punctuation marks and a determination of text passages of the output text relating to accentuation and pauses;
an analysis of formatting of the output text;
an analysis of word importance in the output text; and/or
a classification of a recipient;
wherein the text analysis service is configured to output a result of the text analysis service in the form of output text analysis metadata;
wherein the network is configured to: transfer the output text, the output text analysis metadata, and user metadata to a categorization service which selects at least one output medium for presenting the output text to a user; and
wherein the output medium is configured to present the output text to the user.

14. The system according to claim 13, wherein the network comprises a speech recognition unit.

15. The system according to claim 13, wherein the at least one output medium is associated with the user.
